(19) United States
(12) Patent Application Publication
(10) Pub. No.: US 2006/0289424 A1
(43) Pub. Date: Dec. 28, 2006

(54) Double feed detecting apparatus and image forming apparatus

(75) Inventor: Eiji Ishii, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/418,855

(22) Filed: May 5, 2006

(30) Foreign Application Priority Data
May 13, 2005 (JP) 2005-141029

(51) Int. Cl. H05B 3/02

(52) U.S. Cl. 219/243

(57) ABSTRACT

A double feed detecting apparatus includes an ultrasonic wave transmitter configured to transmit an ultrasonic wave to a sheet, an ultrasonic wave receiver configured to receive the ultrasonic wave transmitted by the ultrasonic wave transmitter, a comparison device configured to compare the signal received by the ultrasonic wave receiver with a predetermined threshold, and a double feed detecting device configured to detect a double-feed based on the comparison result of the comparison device. The double feed detecting device calculates the threshold before detecting the double feed.

### BACKGROUND OF THE INVENTION

1. Field of the Invention

The present invention relates to a double feed detecting apparatus and an image forming apparatus. More particularly, the present invention relates to a circuit constitution and an initialization process of a double feed detecting sensor in the double feed detecting apparatus, and an image forming apparatus equipped with the double feed detecting device.

2. Description of the Related Art

Conventionally, in the POD (print on demand) market, high productivity is required, and in order to meet the requirement, POD systems have been proposed in which double-feed of sheets is detected and reprint is performed leaving out the double-fed sheets, or the double-feed is indicated as an error.

As a double feed detecting apparatus, an apparatus using an ultrasonic wave is known. In the double feed detecting apparatus, various improvements for increasing accuracy of the double feed detection have been made.

For example, Japanese Patent Application Laid-open No. 2000-25987 discusses a structure in which a reception of an ultrasonic wave is limited within a predetermined time period so that only a direct ultrasonic wave sent from a transmitter can be observed. Further, it is determined whether the reception level of the ultrasonic wave exceeds a predetermined threshold, and based on the determination, double-feed detection in which reflection waves and standing waves are excluded, is performed.

Further, as discussed in Japanese Patent Application Laid-open No. 2003-176063 (corresponding to U.S. Pat. No. 6,739,591), a structure for detecting double-feed by a phase difference of a received ultrasonic wave is proposed. In the structure, the number of times the phase difference occurs, is counted and, if the counted number exceeds a predetermined threshold, it is determined that the double-feed has occurred.

In a double feed detecting apparatus using an ultrasonic wave sensor, as shown in FIG. 2, an ultrasonic wave is transmitted from a transmitter 312-a and received by a receiver 312-b. Then, the waveforms of the transmission wave and the reception wave appear as shown in FIG. 1, and the rectified and smoothed reception signal is used for the double-feed detection.

In a case where the double feed detecting apparatus is drawn out by a user, the position of the double feed detecting apparatus can be displaced. As shown in FIG. 2, if the position of the transmitter 312-a is displaced by Δx1 and the position of the receiver 312-b is displaced by Δx2, a distance L between the transmitter 312-a and the receiver 312-b is displaced by ΔL, where, ΔL=|Δx1−Δx2|.

As described above, when the distance between the transmitter 312-a and the receiver 312-b changes, the waveform of the rectified and smoothed signal changes accordingly. Further, depending on materials or thickness of conveyed sheets, the waveform of the rectified and smoothed signal varies.

FIG. 3 illustrates a relationship between amplitude levels and thresholds. A condition 1 has higher levels of reception signals than a condition 2 since a distance between the transmitter 312-a and the receiver 312-b in the condition 1 is shorter, and the thickness of conveyed sheets is thinner than the condition 2. In a case of the condition 1, the threshold 1 should be set. However, in a case of the condition 2, the threshold 2 should be set smaller than the threshold 1. That is, the longer the distance between the transmitter 312-a and the receiver 312-b becomes, or the thicker the sheets become, the smaller the amplitude of the rectified and smoothed signal becomes. Therefore, it is not possible to set a fixed threshold for determining the double-feed.

### SUMMARY OF THE INVENTION

The present invention is directed to a double feed detecting apparatus.

The present invention is directed to a double feed detecting apparatus configured to increase accuracy of double-feed detection with a simple structure.

According to one aspect of the present invention, a double feed detecting apparatus includes an ultrasonic wave transmitter configured to transmit an ultrasonic wave to a sheet, an ultrasonic wave receiver configured to receive the ultrasonic wave transmitted by the ultrasonic wave transmitter, a comparison device configured to compare the signal received by the ultrasonic wave receiver with a predetermined threshold, and a double feed detecting device configured to detect double-feed based on the comparison result of the comparison device. The double feed detecting device calculates a calculated threshold before detecting the double feed.

According to another aspect of the present invention, a double feed detecting apparatus includes an ultrasonic wave transmitter configured to transmit an ultrasonic wave to a sheet, an ultrasonic wave receiver configured to receive the ultrasonic wave transmitted by the ultrasonic wave transmitter, a signal amplification device configured to amplify the signal received by the ultrasonic wave receiver at a predetermined gain, a comparison device configured to compare the signal amplified by the amplification device with a predetermined threshold, and a double feed detecting device configured to detect double-feed based on the comparison result of the comparison device. The double feed detecting device sets the gain of the signal amplification device before detecting the double feed.

Further exemplary embodiments, aspects and features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate numerous exemplary embodiments, features and aspects of the invention and, together with the description, serve to explain the principles of the invention.

FIG. 1 illustrates waveforms used in a double feed detecting apparatus using an ultrasonic wave sensor.

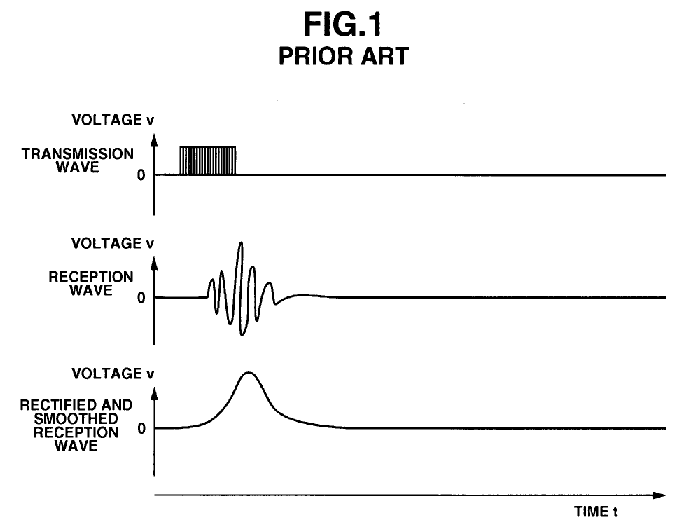

FIG. 2 illustrates an error factor in an amplitude level of a received ultrasonic wave.

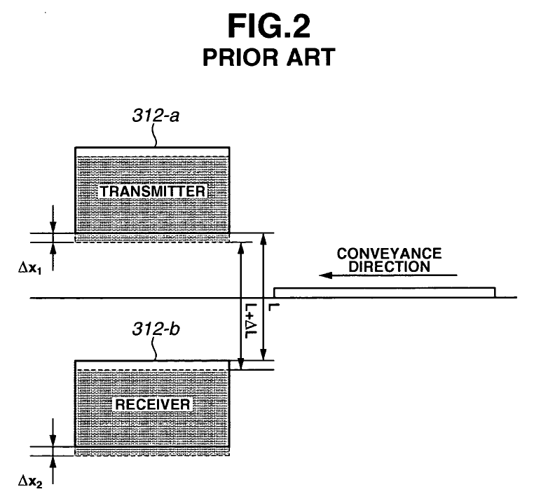

FIG. 3 illustrates a relationship between differences of amplitude levels of a received wave and thresholds.

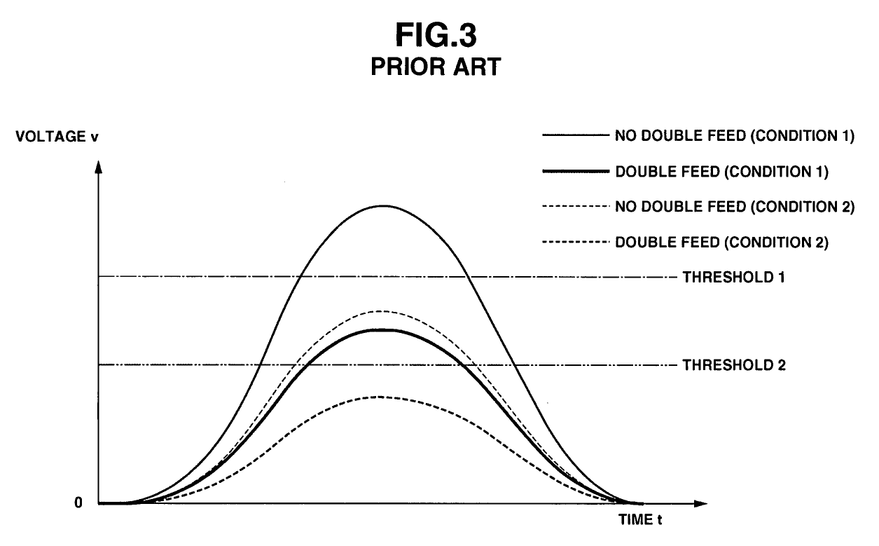

FIG. 4 illustrates a structural view of an image forming apparatus according to an exemplary embodiment of the present invention.

FIG. 5 illustrates a block diagram of a double feed detecting apparatus according to an exemplary embodiment of the present invention.

FIG. 6 illustrates a flowchart of an operation flow of a double feed detecting apparatus according to an exemplary embodiment of the present invention.

### DETAILED DESCRIPTION OF THE EXEMPLARY EMBODIMENTS

Various exemplary embodiments, features, and aspects of the present invention will now be herein described in detail below with reference to the drawings.

Structure of an Image Forming Apparatus

An image forming apparatus according to an exemplary embodiment of the present invention forms an image, that is transmitted as an electronic signal, on a regular sheet, heat-sensitive paper, or the like by means of an electrophotographic system, heat-sensitive system, thermal-transfer system, inkjet system, or the like. In the exemplary embodiment, an image forming apparatus in the electrophotographic system using a laser beam exposure method is employed as an example.

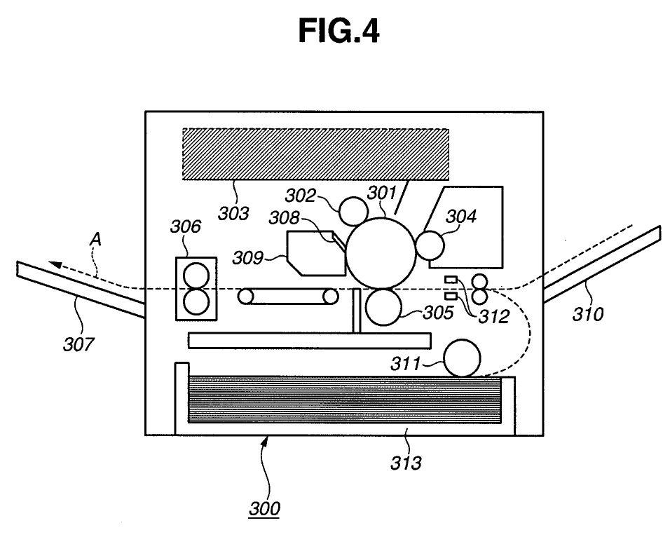

FIG. 4 illustrates a structure of an image forming apparatus 300. An optical semiconductor layer is formed on a photosensitive drum 301. Electrical characteristics of the optical semiconductor layer varies depending on light irradiations, and rotates at a constant speed during an image forming operation. The image forming operation is performed according to the following steps: (1) charge; uniformly charging the optical semiconductor layer on the photosensitive drum 301 by a charger (charging roller) 302, (2) laser exposure; irradiating an image pattern (that is to be an electrostatic latent image) toward the photosensitive drum by a laser optical system 303, (3) development; causing toner to adhere to the electrostatic latent image by a developing unit 304, (4) transfer; transferring the toner on a recording material (hereinafter, referred to as recording paper) by a transferring roller 305, (5) fixation; fixing the toner on the recording paper by heating and pressing the recording paper by a fixing unit 306 and the recording paper is discharged on a discharge tray 307, (6) cleaning; residual toner which is not transferred and remains on the drum is removed by a blade 308, and the removed toner is accumulated in a waste toner container 309.

The image forming operation is performed according to the above steps. The recording paper is stacked in a cassette 313 or a manual feed tray 310, and conveyed onto the drum surface by a feeding roller 311. Then, detection is performed by a double feed detecting device 312 to determine whether the recording papers are double fed.

The double feed detecting device 312 is arranged at an upstream side of the photosensitive drum 301 with respect to a sheet conveying direction. Thus, the double feed detecting device 312 can detect the double-feed before the image is formed on the sheet.

Further, the double feed detecting device 312 is arranged at a downstream side of a joining point of a conveyance path from the cassette 313 and a conveyance path from the manual feed tray 310. Thus, it is not necessary to provide the double feed detecting device 312 for each of the conveyance path from the cassette 313 and the manual feed tray 310. Accordingly, the cost can be reduced.

Structure of the Double Feed Detecting Device

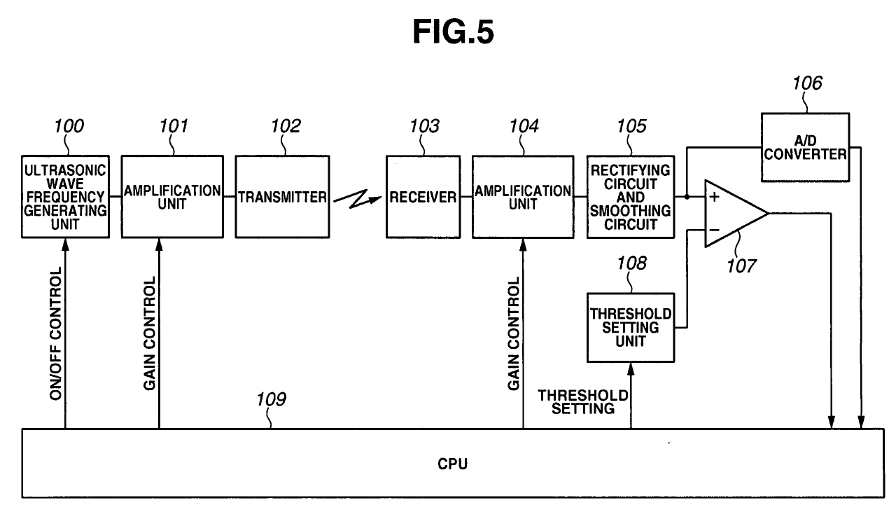

A structure of the double feed detecting device 312 will be described in detail with reference to FIG. 5.

An ultrasonic wave frequency generating unit 100 generates a frequency of ultrasonic wave used for double-feed detection, and the generation of the frequency is turned on/off by the control of a CPU 109. An amplification unit 101 amplifies the signal generated in the ultrasonic wave frequency generating unit 100, and the gain is controlled by the CPU 109.

A transmitter 102 transmits the signal amplified in the amplification unit 101 as an ultrasonic wave, and the transmitted ultrasonic wave is sent to a receiver 103 passing through a sheet.

The receiver 103 receives the ultrasonic wave transmitted by the transmitter 102, and converts the ultrasonic wave into a voltage signal.

An amplification unit 104 amplifies the received signal, and the gain is controlled by the CPU 109.

A rectifying and smoothing circuit 105 rectifies and smoothes the received signal, and generates an envelope waveform of reception waveform.

An analog to digital converter (A/D converter) 106 converts analog data into digital data, and sends the digital data to the CPU 109.

A comparator 107 compares a voltage set in a threshold setting unit 108 with the envelope waveform of the received signal, and determines whether the envelope waveform exceeds the threshold.

The threshold setting unit 108 sets the reference voltage used for the comparison in the comparator 107, and the value is set by the CPU 109.

The CPU 109 controls the entire system and initializes the gain in the amplification unit 104 or the threshold at an initialization stage in the threshold setting unit 108. Further, the CPU 109 performs control to reduce the variation of the reception signal level that arises due to used materials or thickness of sheets, or distances between the transmitter and receiver.

Control Flow of the Double Feed Detecting Device

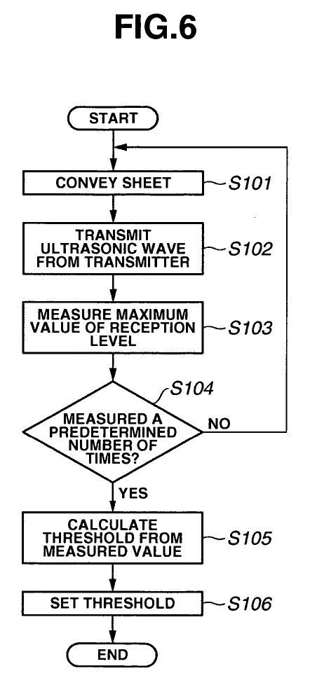

A control flow of the double feed detecting device 312 will be described with reference to FIG. 6. The control flow of the double feed detecting device 312 is, for example, performed when the power source of the image forming apparatus 300 is turned on.

First, in order to measure a reception voltage level in a non-double-feed state, the CPU 109 controls the feeding roller 311 and conveys a sheet on which an image is to be formed (step S101). Then, the transmitter 102 transmits an ultrasonic wave for detecting a double-feed (step S102). Then, the receiver 103 receives the ultrasonic wave transmitted at step S102. The A/D converter 106 converts the received analog value into a digital value, the CPU 109 reads the value, and a maximum amplitude of the reception wave is measured (step S103). In order to average the maximum amplitude of the reception wave, the processing returns to step S101 until the measurements are performed a predetermined number of times (step S104). For example, the maximum amplitude of the reception wave is measured five times. After the measurements are performed the predetermined number of times to calculate the average of the maximum amplitude of the reception wave, a threshold is calculated (step S105). For example, the threshold can be an average value of the maximum amplitude×0.7. Finally, the value calculated at step S105 is set to the threshold setting unit 108, and the initialization is completed (step S106).

By carrying out the control flow of the double feed detecting device, it is possible to perform the initialization corresponding to a distance from the detection sensor in the double feed detecting device 312, and materials and thickness of the sheet. Thus, it can be possible to perform an accurate double-feed detection.

The flow for setting the threshold by initialization is described above. However, it can be possible to perform the initialization by adjusting the gains in the amplification units 101 and 104 to standardize the reception waveforms.

Further, the initialization can be performed by providing a sensor for detecting that the position of the double feed detecting device 312 has been displaced. When the displacement of the double feed detecting device 312 is detected, the initialization can be performed. Thus, even if the amplitude of the reception wave varies due to the displacement of the double feed detecting device 312, the double-feed can be accurately detected.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2005-141029 filed on May 13, 2005, which is hereby incorporated by reference herein in its entirety.

What is claimed is:

1. A double feed detecting apparatus comprising:
an ultrasonic wave transmitter configured to transmit an ultrasonic wave to a sheet;
an ultrasonic wave receiver configured to receive the ultrasonic wave transmitted by the ultrasonic wave transmitter;
a comparison device configured to compare the signal received by the ultrasonic wave receiver with a predetermined threshold; and
a double feed detecting device configured to detect double-feed based on the comparison result of the comparison device,
wherein the double feed detecting device calculates a calculated threshold before detecting the double feed.

2. The double feed detecting apparatus according to claim 1, wherein the double feed detecting device measures a reception level of the ultrasonic wave receiver in a non-double-feed state by feeding paper, and calculates the calculated threshold in accordance with the measured reception level.

3. The double feed detecting apparatus according to claim 1, further comprising a rectifying and smoothing device congifured to rectify and smooth the ultrasonic wave received by the ultrasonic wave receiver.

4. The double feed detecting apparatus according to claim 3, wherein the comparison device compares the ultrasonic wave rectified and smoothed by the rectifying and smoothing device with the predetermined threshold.

5. The double feed detecting apparatus according to claim 1, wherein the double feed detecting device calculates the calculated threshold when a power source is turned on.

6. The double feed detecting apparatus according to claim 1, further comprising a sensor configured to detect that the double feed detecting device is displaced.

7. The double feed detecting apparatus according to claim 6, wherein the double feed detecting device calculates the calculated threshold in response to the detection of the displacement of the double feed detecting device by the sensor.

8. An image forming apparatus comprising:
the double feed detecting apparatus according to claim 1;
a cassette configured to stack sheets;
a manual feed tray configured to stack sheets; and
an image forming device configured to form an image on a sheet fed by one of the cassette and the manual feed tray.

9. The image forming apparatus according to claim 8, wherein the double feed detecting apparatus is arranged at an upstream side of the image forming apparatus seen in a sheet feeding direction.

10. The image forming apparatus according to claim 8, wherein the double feed detecting apparatus is arranged at a downstream side of a joining point of a feeding path from the cassette and a feeding path from the manual feed tray.

11. A double feed detecting apparatus comprising:
an ultrasonic wave transmitter configured to transmit an ultrasonic wave to a sheet;
an ultrasonic wave receiver configured to receive the ultrasonic wave transmitted by the ultrasonic wave transmitter;
a signal amplification device configured to amplify the signal received by the ultrasonic wave receiver at a predetermined gain;
a comparison device configured to compare the signal amplified by the amplification device with a predetermined threshold; and
a double feed detecting device configured to detect double-feed based on the comparison result of the comparison device,
wherein the double feed detecting device sets the gain of the signal amplification device before detecting the double feed.

12. An image forming apparatus comprising:
the double feed detecting apparatus according to claim 11;
a cassette configured to stack sheets;
a manual feed tray configured to stack sheets; and
an image forming device configured to form an image on a sheet fed by one of the cassette and the manual feed tray.

13. The image forming apparatus according to claim 12, wherein the double feed detecting apparatus is arranged at an upstream side of the image forming device seen in a sheet feeding direction.

14. The image forming apparatus according to claim 12, wherein the double feed detecting apparatus is arranged at a downstream side of a joining point of a feeding path from the cassette and a feeding path from the manual feed tray.
